(19) United States
(12) Patent Application Publication
(10) Pub. No.: US 2023/0005248 A1
(43) Pub. Date: Jan. 5, 2023

(54) MACHINE LEARNING (ML) QUALITY ASSURANCE FOR DATA CURATION

(71) Applicant: SAMASOURCE IMPACT SOURCING, INC., San Francisco, CA (US)

(72) Inventors: Loic JUILLARD, Novato, CA (US); Frederic RATLE, Montréal (CA)

(73) Assignee: SAMASOURCE IMPACT SOURCING, INC., San Francisco, CA (US)

(21) Appl. No.: 17/944,859

(22) Filed: Sep. 14, 2022

Related U.S. Application Data
(63) Continuation-in-part of application No. 17/151,123, filed on Jan. 16, 2021, now Pat. No. 11,481,577.
Application No. 17/151,123 is a continuation-in-part of application No. 17/145,292, filed on Jan. 9, 2021, now Pat. No. 11,270,438.
(60) Provisional application No. 63/038,358, filed on Jun. 12, 2020.

(51) Int. Cl. G06V 10/776; G06V 10/774; G06V 20/70

(52) U.S. Cl. CPC G06V 10/776; G06V 10/774; G06V 20/70

(57) ABSTRACT

Systems and method for assessing annotators by way of annotated images annotated by said annotators. Agent or annotator model modules are trained using annotated images annotated by specific annotators. A baseline model module is also trained using all of the annotated images used in training the agent model modules. The trained agent model modules are then used to annotate an evaluation dataset to result in evaluation result annotated images. The trained baseline model module is also used to annotate the evaluation dataset to result in its own evaluation result annotated images. The evaluation results from the agent model modules are compared with the evaluation result from the baseline model module. Based on the comparison results, scores are allocated to each agent model module. The scores are used to group agent model modules and annotators that correspond to the low scoring agent model modules can be targeted for retraining.

### CROSS REFERENCE TO RELATED APPLICATIONS

This application is a continuation-in-part of U.S. patent application Ser. No. 17/151,123, filed Jan. 16, 2021, entitled MACHINE LEARNING (ML) QUALITY ASSURANCE FOR DATA CURATION, which is a continuation-in-part of U.S. patent application Ser. No. 17/145,292, filed Jan. 9, 2021, and issued as U.S. Pat. No. 11,270,438, on Mar. 8, 2022, entitled SYSTEM AND METHOD FOR TRIGGERING MACHINE LEARNING (ML) ANNOTATION MODEL RETRAINING, which claims the benefit of and priority to U.S. Provisional Application No. 63/038,358, filed Jun. 12, 2020, entitled SYSTEM AND METHOD FOR CONVERTING A RASTER MASK TO A SPARSE POLYGON, the contents of each of these aforementioned applications are hereby incorporated by reference as if fully set forth herein.

### FIELD OF INVENTION

This invention generally relates to machine learning (ML) systems and, more particularly, to systems and methods for measuring the quality of annotations in images to be used for machine learning

### BACKGROUND

When developing an ML model that relates to images or image processing, a training dataset is created containing images representative of the environment in which the model is to operate. A training dataset is a set of images that have been annotated to identify/label relevant items in the images. As can be imagined, an annotation is a form of marking on the image where features of interest (e.g., objects or scenes) are highlighted in the picture. Annotation may also involve placing a box or a precise contour around the feature(s) of interest.

Training datasets are typically annotated by humans and there is a correlation between results obtained from trained ML models and training data annotation accuracy, so annotation accuracy is essential for training data sets. Accurately annotated data sets produce trained models that give better results.

It should be clear that each customer project (annotation feature) is not static. A customer tends to send batches of data collected in different environments or with different sensors without particular instructions. For example, a customer may send a batch of data consisting of highway images taken during the day, with the next series of data being a set of night pictures taken in a city, or a set of data taken with a different lens, etc. Of course, the day time images are easier/faster to annotate compared to the night time images. Regardless of the circumstances of the image data sent by the customer, all these images still need to be properly and accurately annotated. Customers do not always communicate changes with their data submissions nor do they always understand that the varied circumstances surrounding their data sets have a resulting impact on annotation quality and/or time.

In addition to the varied circumstances surrounding customer provided images, customers may also change the annotation instructions during a project. For example, customers may provide images with road scenes and may request annotations of cars, including any mirrors on the cars. Later on in the project, the customer may realize that the mirrors create false positives and, as such, the customer changes their annotation instructions to no longer include the mirrors on the cars. This poses two issues—for this change in instruction, the customer must generate an official project requirement change, which is not always as easy as it might seem. Second, each and every human annotating agent on the project must be made aware of the change, which can be difficult if there are, for example, 600-1000 agents.

Because the customer data being receiving is unique, there is no ability to programmatically compare the annotated images produced by agents with a “perfect” version of this annotation—so detecting, grading, and correcting the annotations, has to be done manually. In addition to the overhead of manual testing, while some issues are outright “misses”, other issues are caused by misunderstandings of customer requirements.

Agents whose tasks were rejected often do not understand the error made, and how they should have annotated the content.

Currently, the industry is using 3 techniques to guarantee data quality:

Multiple submissions: have different agents annotate the same content and submit the annotation back to the customer. The issue is cost, since the content is processed multiple times. Also, as the dataset size increase, economy of scale cannot be realized.

Quality control (QC): have experts sample the data (e.g., a 100% sample) and identify gaps/issues. With this methodology, the cost is also an issue since expert time is expensive. Also, experts may not fully understand the customer requirements and wrongly validate, or invalidate the annotations. Alternatively, a small number of tasks may be sampled and a statistical hypothesis test is run to measure if the overall dataset reaches a predefined quality criterion that may be dependent on the sample size.

Gold tasks: A set of tasks that are carefully annotated (possibly by specialists) to build a ground truth dataset (called a gold set, or gold dataset). At regular intervals, these tasks are re-submitted to agents unannotated, and the result of their annotation is compared with the gold dataset. This method would seem to solve the issues brought up by the first two methodologies, but in practice, agents tend to memorize the gold dataset rapidly. Thus, the gold dataset should be very large, and this causes this method to be as equally costly as other methods.

It would be advantageous if an automated system/method can be found that can automatically assess the work product of annotators. Preferably, such a system/method avoids the costs and issues surrounding the prior art.

### SUMMARY

The present invention provides systems and method for assessing annotators by way of annotated images annotated by said annotators. Agent or annotator model modules are trained using annotated images annotated by specific annotators. A baseline model module is also trained using all of the annotated images used in training the agent model modules. The trained agent model modules are then used to annotate an evaluation dataset to result in evaluation result annotated images. The trained baseline model module is also used to annotate the evaluation dataset to result in its own evaluation result annotated images. The evaluation results from the agent model modules are compared with the evaluation result from the baseline model module. Based on the comparison results, scores are allocated to each agent model module. The scores are used to group agent model modules and annotators that correspond to the low scoring agent model modules can be targeted for retraining.

In a first aspect, the present invention provides a system for assessing a plurality of annotators that produce annotated images, said annotated images having been annotated by said plurality of annotators comprising:

a) a plurality of trained annotator model modules for annotating images, each of said trained annotator model modules corresponding to one of said plurality of annotators, and each of said trained annotator model modules being trained on annotated images as annotated by a specific annotator that corresponds to said trained annotator model;

b) a trained baseline model module for annotating images, said trained baseline model being trained on all annotated images used to train said plurality of annotator model modules;

c) a comparison module for comparing an evaluation output of said trained baseline model module with an evaluation output of one or more of said trained annotator model modules, said evaluation output being an output of a trained model module when an evaluation dataset is passed through said trained model module;

d) a scoring module for producing scores for each of said trained annotator model modules, each score being a numerical indication of differences between said evaluation output of said trained baseline model module with said evaluation output of one of said trained annotator models, said numerical indication being based on an output of said comparison module.

In a second aspect, the present invention provides a method for assessing a plurality of annotators that produce annotated images, said annotated images being annotated by said plurality of annotators, the method comprising:

a) receiving a plurality of annotated images, said plurality of annotated images being annotated by said plurality of annotators;

b) training a plurality of annotator model modules using said plurality of annotated images such that each of said plurality of annotator model modules is trained using annotated images that have been annotated by a corresponding specific one of said plurality of annotators;

c) training a baseline model module using said plurality of annotated images received in step a) such that said baseline model module is trained using all of said annotated images used in training said plurality of annotator model modules;

d) processing an evaluation dataset using said plurality of annotator model modules to result in evaluation outputs of annotated images, each of said plurality of annotator model modules producing an evaluation output of annotated images;

e) processing said evaluation dataset using said baseline model module to result in a corresponding evaluation output of annotated images;

f) comparing evaluation outputs of each of said plurality of annotator model modules with said evaluation output of said baseline model module;

g) scoring each of said plurality of annotator model modules based on results of step f) to result in at least one score for each of said plurality of annotator model modules.

In a further aspect, the score is a numerical indication of differences between the evaluation output of the trained baseline model with the evaluation output of one of the trained annotator models in at least one rubric, the at least one rubric being related to at least one of: Recall, Label Accuracy, Precision/Shape Overlap, Tracking, and Points per shape. The scoring module, in one implementation, scores each of the trained annotator models separately for each of the at least one rubrics.

The evaluation dataset may be at least one of:

a set of visually diverse images;

a set of selected images by a customer and/or an operational team; and

a gold dataset.

The system may further comprise an analysis module for analyzing scores from said scoring module. This analysis module outputs a listing of the trained annotator models, this listing of trained annotator models being organized based on scores received by said trained annotator models.

In one variant, the listing of trained annotator models is divided into discrete groups of trained annotator models such that trained annotator models with lowest overall scores are grouped together. In another variant, the listing of trained annotator models is divided into discrete groups of trained annotator models such that trained annotator models with lowest scores in a given rubric are grouped together.

The annotators corresponding to annotator model modules with the lowest overall scores may be targeted for retraining. As well, annotators corresponding to annotator model modules with the lowest scores in a given rubric may be targeted for retraining in a specific task corresponding to said rubric.

### BRIEF DESCRIPTION OF THE DRAWINGS

The embodiments of the present invention will now be described by reference to the following figures, in which identical reference numerals in different figures indicate identical elements and in which:

FIG. 1 is a block diagram for a system for machine learning annotation quality assurance;

FIG. 2 is a functional block diagram schematically illustrating the steps executed by the system illustrated in FIG. 1;

FIG. 3 visually illustrates an Intersection over Union technique for scoring evaluation outputs as used in one aspect of the present invention;

FIG. 4 is a flowchart detailing the steps in a method according to one aspect of the present invention.

### DETAILED DESCRIPTION

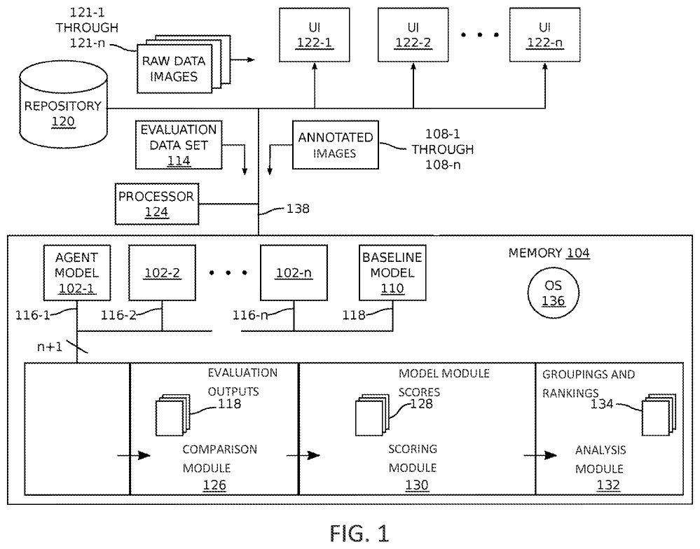

FIG. 1 is a schematic block diagram depicting a system for machine learning (ML) quality assurance. The system 100 comprises a plurality of agent ML annotation model software modules 102-1 through 102-n. Each agent annotation model module is stored in a non-transitory memory 104 and enabled as a sequence of processor 106 executable steps for annotating images as trained from a set of annotated images that have been annotated by a specific annotator (who may be a human annotator/agent). Each specific annotator produces a set of annotated images 108-1 through 108-n including a first shape. The purpose of each of the agent model modules 102-1 through 102-n is to be trained in annotating unannotated images using a set of annotated images annotated by a specific annotator. The performance of each agent model modules in annotating can then be measured and, by doing so, the performance of the annotator that annotated the corresponding set of annotated images used to train that agent model module is indirectly measured. Of course, as part of the annotation, an annotated image will include annotation marks that form a boundary surrounding a first shape. Some examples of annotation marks include a raster mask, bounding box, polygon, key point annotation, vector annotation, line, semantic segmentation (a type of raster), and instance semantic segmentation (another type of raster).

For a bounding box, the coarse boundary may be a set of points encompassing an object. For vector (polygonal) segmentation, the coarse boundary may be a list of coordinates (points of the polygon). For raster segmentation, the coarse boundary may be an image file containing pixel masks of the shape being annotated, similar in concept to a transparent page being superimposed on the raw data image shape. In one aspect, annotation may involve concatenating a heatmap from colors within the raw data annotations, match the heatmap to a selected segmentation model, and convert the selected segmentation model into annotation marks (e.g., a raster mask).

As part of the system, a baseline model module 110 is stored in the memory 104 and is enabled as a sequence of processor 106 executable steps for annotating images as trained from all the subsets of annotated images 108-1 through 108-n as produced by the various annotators. The annotated images as produced by the baseline model module may include annotation marks that form a boundary surrounding the first shape.

As should be clear, each agent model module is trained to annotate unmarked images using a specific set of annotated images as annotated by a specific annotator. A baseline model module is trained to annotate unmarked images using all of the annotated images produced by the various annotators. An evaluation dataset is then run through all of the various agent model modules, resulting in evaluation outputs from each of the agent model modules. The evaluation dataset is also run through the baseline model module to result in a corresponding evaluation output for the baseline model module. The evaluation output from each agent model module is then compared/scored/evaluated against the evaluation output from the baseline model module.

For clarity, the comparison/scoring/evaluation of each agent model module's evaluation output against the evaluation output of the baseline model module is performed using specific rubrics. This is done to assess the resulting annotated images from the agent model modules against the resulting annotated images from the baseline model module. The comparison/assessment/evaluation results in scores for each of the agent model modules. There can be an overall score that is a numerical indication of how similar the annotated images from an agent model module are to the annotated images from the baseline model module. Similarly, there can be specific scores for specific rubrics, with each score being a numerical indication of how good each agent model module is at performing a specific annotation task as compared to the performance of the baseline model module. The resulting scores for each rubric for each of the agent model modules can then be used to group the agent model modules based on the scores. Specific groups can be created for poor performing model modules (i.e. those with low scores) for each annotation task as indicated by the specific rubric. Of course, if a specific agent model module is included in a specific group for poor performing agent model modules for a specific annotation task, this means that the annotator whose work product was used to train that specific agent model module may need more training in that specific annotation task.

To assess the performance of the agent model modules, a comparison component/comparison module 126 is used. The performance of each agent model module is compared with the performance of the baseline model module. For such a comparison, the evaluation dataset is used to result in evaluation outputs for each of the various agent model modules and the baseline model module. These evaluation outputs are then compared using a comparison module and the results of the comparison are scored. The resulting scores are then assessed by an analysis module that ranks/groups the agent model modules according to the scores that each of the agent model modules receive based on the various rubrics used.

A comparison component/comparison module 126 takes the evaluation outputs 118 from the various agent model modules 102-1 to 102-n and compares these evaluation outputs with the evaluation outputs from the baseline model module 110. The results of the comparison by the comparison module 126 are then passed to the scoring module 130. The scoring module 130 then scores the results of the comparisons to produce the model module scores 128. The scores are then analyzed by the analysis module 132 and the agent model modules are ranked and/or grouped to produce the rankings and groupings 134 based on the rubrics used to rank/group/score the comparison results.

It should be clear that the system 100 may include a plurality of human agent user interfaces (UIs) 122-1 through 122-n. Each UI accepts sets of raw data images 121-1 through 121-n with the first shape from repository 120. Typically, the raw data images are two-dimensional still images, but they may also be three-dimensional (3D) point cloud or 3D vector data, or video content. Through the UI, an annotator annotates one set of raw data images to produce sets of annotated images 108-1 to 108-n. Thus, as an example, annotator 1 may use UI 122-1 to receive a set of raw data images 121-1. The set of raw data images 121-1 is then annotated by annotator 1 to produce a set of annotated images 108-1. This set of annotated images 108-1 is then used to train agent model module 102-1. The annotated images produced by an annotator is used to train corresponding agent model modules 102-1 through 102-n. The UIs typically comprise elements such as a display, keypad, mouse, touchpad, touchscreen, trackball, stylus, or cursor direction keys, and voice-activated software, to name a few examples.

For clarity, agent model module 102-n is trained using a set of annotated images 108-n produced by annotator n by way of UI 122-n. It should also be clear that baseline model 110 is trained using all of the sets of annotated images 108-1 to 108-n.

Once the various agent model modules 102-1 to 102-n have been trained using one of the corresponding sets of annotated images 108-1 to 108-n, the performance of each of the agent model modules 102-1 to 102-n can be assessed. To perform the assessment, an evaluation data set 114 is used. The evaluation data set 114 is processed separately by each of the agent model modules 102-1 to 102-n and by the baseline model 110 to result in evaluation outputs 118. The comparison module 126 compares these evaluation outputs 118 and the comparison results are scored using the scoring module 130. The scoring produces model module scores 128 and these scores are used by the analysis module 132 to group and/or rank the various agent model modules 102-1 to 102-n.

It should be clear that, when the agent model modules and the baseline model module process the evaluation data set to produce annotated images, different tasks are performed. These tasks include classification, localization, and segmentation. It should be clear that localization involves producing the boxes while segmentation involves producing the polygons or masks for the features of interest. For the classification tasks, the modules determine a class of shapes into which falls the shape identified by the annotation marks in the annotated images. For localization tasks, the modules determine the image coordinates of the first shape identified by the annotation marks in the annotated images. As noted above, for segmentation, a polygon or raster mask is produced around the object of interest. Finally, the modules also produce probability predictions that determine the statistical probability of the localization and classification executions being accurate. In essence, each agent model module processes the evaluation data to predict how a specific annotator would annotate each image in the evaluation dataset. Each agent model module “learns” how each annotator annotates images and, based on what has been “learned”, the agent model module predicts how the specific corresponding annotator would annotate the images in the evaluation data set. Then, the resulting evaluation outputs (the prediction as to how a specific annotator would annotate images in the evaluation dataset) are then compared to the evaluation output from the baseline model module.

Scoring the results of the comparison between the evaluation outputs uses the concepts of recall, label accuracy, precision, tracking, and points per shape.

### Recall

Recall involves the presence or absence of an annotated shape for a relevant object (i.e., a class) on the media (e.g. the image, video, 3D object, etc.) being annotated. Recall answers the questions, has the agent missed any object they were supposed to annotate or has the agent annotated a class that shouldn't have been annotated?

This metric is calculated by counting the number of shapes determined in the evaluation output by the baseline model module and comparing this number with the shapes determined by the agent model in its evaluation output. Because two errors may cancel out each other (e.g. an agent might have annotated more shapes than it should have, and also might have missed others), the shape count is associated with a general positioning of a corresponding shape from the baseline model module's evaluation output. The shape from an agent model module's evaluation output should be within a given percentage of a corresponding shape from the baseline model modules evaluation output.

The scoring may be as follows:

If a shape in the evaluation output of an agent model module is annotated (i.e., identified/marked) and is in the general location of a corresponding shape in the evaluation output of the baseline model module, that agent model module receives 1 point.

If the agent model module's evaluation output annotates a shape that does not correspond to a shape in the general location in the evaluation output for the baseline model module, or if, in a general location in the evaluation output of the baseline model module, there is an annotated shape and the corresponding shape is not found in the evaluation output for the agent model module (i.e. the agent model module did not annotate a specific shape in that general location), the specific agent model module receives 0 points.

In one implementation, the recall final score is calculated as the average points awarded divided by the count of classes (i.e. the number of relevant objects) from the baseline model module's evaluation output.

It should be clear that, for video and 3D point clouds, recall scores and other matters that are based on or affect recall is determined on a frame by frame basis. Depending on customer requirements, each agent model module, for each shape, may receive a weighted (prorated) score for missed frames (where an object is annotated in the video but is missed in certain frames) or receives a 0 for any frame missed (some customers consider the annotation faulty if the shape is missed in any frame, even if the object is only very partially visible—accordingly, if an object is even partially visible in a frame but is not annotated even if only partially visible, then the agent model module is given a zero for that frame).

### Label Accuracy

As with the previous rubric, label accuracy is calculated by comparing the shapes from the evaluation outputs of the agent model modules with the evaluation output of the baseline model module.

For each shape in each agent model module's evaluation output that has a close match in the evaluation output of the baseline model module, the label for the shape in the agent model module's evaluation output is compared to the label for the shape in the baseline model module's evaluation output. An accurate label between the two evaluation outputs receives 1 point while an inaccurate or wrong label receives 0 points.

The scope for this rubric is the average number of correct labels to the total number of labels for the annotated media.

### Precision/Shape Overlap

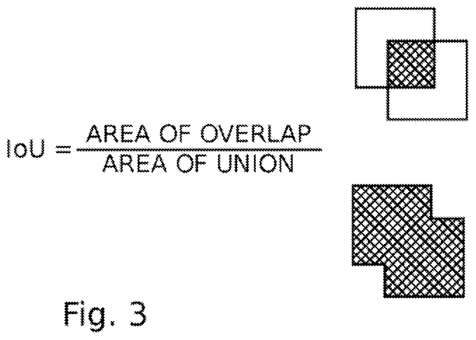

The scoring for precision is calculated using a common ML technique called IoU (Intersection over Union). IoU is calculated by dividing the area of overlap (between the two shapes) by the area of union of the two shapes. FIG. 3 visually illustrates the calculation of the IoU.

For each shape predicted by the agent model module in its evaluation result, the IoU with the baseline model module's evaluation result shape is calculated. If a shape is missing in the agent model module's evaluation result, the agent receives 0 for that shape. If a shape is present in the agent model modules evaluation result (i.e. the agent model module's annotated output), but missing in the baseline model module's evaluation result, the agent also receives 0. The score in this category is the average IoU for all shapes on the media annotated.

### Tracking

The tracking rubric only applies to 3D images and video that is to be annotated. It should be clear that, for video, annotators are sometimes asked to indicate in which direction a shape is going. This is done using a vector or dominant face on a cuboid facing the direction of travel.

Assessment of this metric is performed by measuring the angle from the baseline model vector:

If the angle is between 0 and the customer quality threshold (per customer annotation instructions), 1 point is attributed to the annotation;

If the angle is outside the boundaries given above, a zero is attributed to the annotation.

The final scoring for this rubric is the sum of points allocated or attributed to the annotation and then dividing that number by the number of objects (or classes) annotated.

### Points Per Shape

This rubric only applies to polygon annotation or annotating by defining a polygon around an item to be annotated. Since fewer points used to accurately annotate is more efficient (as long as the shape annotated is within customer/client requirements), then the fewer points used to define a shape, then the greater the reward. Additionally, the number of points created is also graded.

For this rubric, much like label accuracy, the shapes from the evaluation outputs of the agent model modules with the evaluation output of the baseline model module are compared.

For each shape that falls within the customer requirements, compare the point count from the evaluation output of the agent model module with the point count for the corresponding shape from the evaluation output of the baseline model module. For each shape, the agent model module performance is assessed using:

Score for a specific shape: 1−(point count for the specific shape from the evaluation output from the agents model module)/(point count for the corresponding shape from the evaluation output of the baseline model module)

For each of the shapes, if the score for that shape is less than zero, the agent model module is awarded 0 points. However, if the score for that shape is greater than zero, then the agent model module performance is awarded the resulting score from the formula. Thus, if the point count from the agent model module is 100 for shape A and the point count from the baseline model module is 90, the score for shape A is thus (1−(100)490))=−0.111. For this example, the agent model module is awarded zero points as −0.111 is less than zero. However, if, for a different shape (e.g. shape B), the point count for the agent model module is 95 and the point count for the baseline model module is 100, then the score for the shape B is thus (1−[(95)/(100)])=0.95.

The final score is the sum of the points allocated for the media annotated. Thus, as an example if there were 3 shapes in an annotated image (taking the examples above of shape A, with 0 score, shape B with score of 0.95, and a shape C with a score of 0.5) the total score for the annotated image is 0+0.95+0.5=1.45.

Once the evaluation outputs from the various agent model modules have been compared (by the comparison module 126) with the evaluation output from the baseline model module, the scores 128 for each comparison are created by the scoring module 130. As should be clear, the scoring module 130 operates according to the above description of how scores are allocated based on how the evaluation outputs are compared. The resulting scores 128 can then be analyzed by the analysis module 132 to create rankings and groupings between the various agent model modules based on their relevant scores.

It should be clear that the analysis module determines, based on the resulting scores, which of the various agent model modules are performing better or worse relative to the other agent model modules. This ranking can be performed by the analysis module 132 such that, for each task performed by the agent model modules, a ranking is produced. These task specific rankings are, of course, score based such that the agent model module with the highest score for a specific task is ranked highest and the rest of the agent model modules are ranked in descending order based on their score. By ranking the agent model modules, the best performing agent model modules for a specific task is isolated. By isolating the best performing agent model module for a task, the annotator that performs that task best is also determined. This annotator is, of course, is the annotator that corresponds to the best performing agent model module for that task.

The rankings produced by the analysis module 132 may be based on more than one task. The rankings may be based on any combination of the available tasks/scores. As an example, the agent model modules may be ranked based on a combination of 3 tasks, tasks A, B, and C. The analysis module thus combines each agent model module's scores for tasks A, B, and C and then ranks the resulting combined scores. Alternatively, the analysis module can rank the various agent model modules based on a combined score that is a combination of all the scores for the various tasks.

Once the rankings have been produced, depending on the configuration, the rankings can be used to remediate issues implied by the resulting rankings and scores. The rankings can indicate that the agent model modules that are at the bottom of the rankings are underperforming. And, since the agent model modules are underperforming, then the annotators who correspond to these agent model modules are equally underperforming relative to the overall group of annotators. Remediation can be performed by determining which annotators correspond to the agent model modules that are high in the rankings (this may not necessarily mean that these agent model modules are at the top of all the rankings) and then designating these annotators as mentors or as annotators tasked with training other annotators.

Note, however, that the simple solution of designating the highly ranked annotators (i.e., the annotators corresponding to the agent model modules that are high in the rankings as mentors or trainers) may not address issues that the various metrics and scores are unable to capture.

In one embodiment, agent model modules are grouped or clustered by productivity, quality of output, and closeness to a desired end result (based on client directives for desired outputs). For each of the various agent model modules, their scores across the different tasks are aggregated and this produces an overall score. Of course, each agent model module's score for each specific task is also relevant. The groupings can be created based on combinations of scores as well as the overall scores. The groupings can be achieved by ranking the rubrics above in order of desired importance as follows:

1. Recall
2. Label Accuracy
3. Precision/Shape Overlap
4. Tracking
5. Points per shape

As can be imagined, given the above, it should be clear that, without proper activation, label accuracy is not possible, without proper label, precision is not relevant, and so on and so forth. Thus, the order of priority may be important for scoring. For example, a low score on item 2 (label accuracy) makes the score for item 3 (precision) less important.

The grouping or clustering of the agent model modules can thus be created based on:

1. Poor activation score
2. Wrong Label accuracy and precision
3. Poor tracking
4. Low Point per shape efficiency

It should be clear that activation relates to an agent model module's productivity—a high activation score means that there is a high correlation between the shapes identified by the baseline model module and the shapes identified by a specific agent model module. A high activation score but a low overall score for an agent model module means that the agent model module is productive but the product is of poor quality, i.e. the resulting product cannot be used as much as it does not conform to what the baseline model module has produced. A low activation score means that the agent model module is not very productive but, if this low activation score is combined with a high overall score, then this means that the productivity is low but the resulting product is of high quality.

The agent model modules can thus be grouped, in one implementation, into 3 categories:

Low yield/Low score
High yield/low score
High yield/high score

The first category is for agent model modules with low activation scores and low overall scores. The second category is for agent model modules that are productive (i.e., high activation scores) but the product is not of very high quality (low overall score). The last category is for agent model modules that are productive and the resulting work product is of high quality.

Once the groupings have been created, the specific agents that correspond to the specific agent model modules in the various groupings are identified and are grouped into the same grouping as their corresponding agent model modules. These groupings (of either or both the agent model modules and of the agents) are then placed into a report. The report can then be communicated to a user that manages the annotators to implement. The annotators corresponding to the agent model modules that are in the high yield/high score category can then be used as trainers/mentors for other annotators.

The results for each grouping of agent model modules can also be used for creating content to be used in training/remediating human annotators who are having issues (as detailed by the performance of their corresponding agent model modules). As an example, for each of the clusters or groupings, the media (images, video or 3D images) with the lowest score by classes (objects categories) can be identified and segregated. Since each annotated image has a given score for each agent model module, then the lowest scoring images for each agent model module can be identified and segregated. These can be used for purposes related to educational training of human annotators. Or, alternatively, the annotated images with the largest difference in scores between the various agent model modules can also be segregated and used as training material. As an example, if an image has a score of 50 for a high performing agent model module but only has a score of 5 for a lower performing agent model module, this image can be selected and set aside for use in training annotators.

Thus, so-called problem images can be images with a large difference in scoring between high performing agent model modules and lower performing agent model modules or they can be images with low scores across most of the agent model modules. Such images can be packaged with the groupings/listings for reporting to a user as explained above.

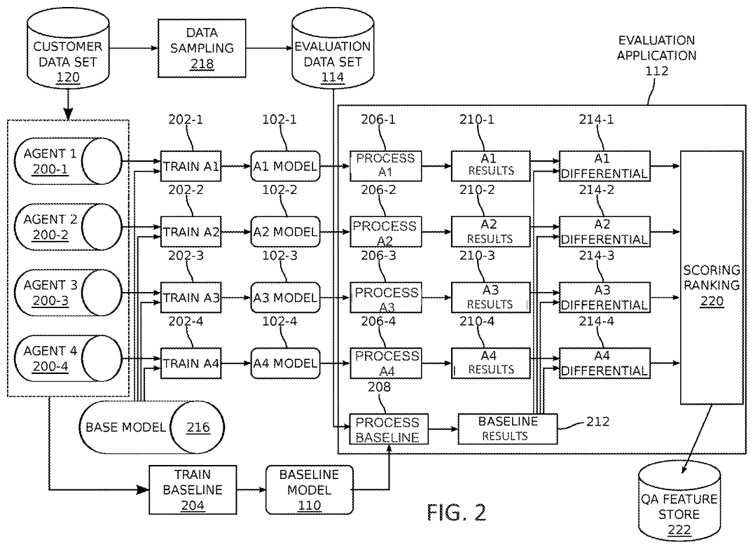

Referring to FIG. 2, FIG. 2 is a diagram depicting the system of FIG. 1 as viewed from a functional perspective. For clarity, rectangular boxes in FIG. 2 with square corners (such as 202-1 to 202-4 and blocks 210-1 to 210-4 and 214-1 to 214-4) are process steps while the blocks with rounded corners (such as blocks 102-1 to 102-4 and block 110) are the resulting components in the system.

Agents 200-1 through 200-4 are annotators that are each provided with a dataset of raw data images, which is a subset of the overall dataset provided by the customer and stored in repository 120. Agents 200-1 to 200-4 annotate the raw data images and the resulting annotated data images are then used to train agent model modules. The training step is detailed by blocks 202-1 to 202-4. As should be clear, the annotated data images produced by each agent 200-1 to 200-4 are used to train just one specific corresponding agent model module such that, for example, the annotated data images produced by agent 1 (200-1) are used to train agent model module A1 (102-1). At the same time, the annotated data images produced by all of the agents 200-1 to200-4 are used to train a base model 216. This training of the base model is designated by process step 204 to result in the trained baseline model module 110. It should be clear that each of the trained agent model modules, prior to training, is an untrained base model 216. Once trained from the specific annotated data from the different agents 200-1 to200-4, the results are the agent model modules 102-1 to 102-4. Similarly, the baseline model module 110 starts out as an untrained base model 216 but, after being trained on all the annotated data images from the agents 200-1 to 200-4, the result is the trained baseline model module 110.

Once the agent model modules 102-1 to 102-4 have been trained, the performance of these agent model modules can then be assessed relative to the performance of the trained baseline model module 110. Using an evaluation dataset 114 that is derived from the customer data set 120, the various agent model modules 102-1 to 102-4 process the evaluation dataset 114. This processing is represented by processing blocks 206-1 to 206-4. At the same time, the baseline model module processes the evaluation dataset 114 as well (process block 208). The results of this evaluation dataset processing are shown as blocks 210-1 to 210-4 and the results for the baseline model module processing of the evaluation dataset is illustrated as block 212.

The results 210-1 to 210-4 of the processing from the agent model modules are then compared/scored against the baseline model module results 212. The scoring/comparison between each of the agent model module results and the baseline model module results are executed by process blocks 214-1 to 214-4 as these compute the differentials between each result dataset and the baseline model module result dataset. The scores from the comparison/scoring are then sent to the scoring/ranking process 220 and the agent model modules are then ranked as necessary.

It should be clear that the agents 200-1 to 200-4 annotate the same images but not the same number of images to result in the annotated data set used to train the corresponding agent model modules. In one example, agent 200-1 annotates 154 images from a total of 550 images in repository 120 sent by the customer. Agent model module 102-1 is then trained using these 154 annotated images. Agent 200-2 annotates 94 images of the 550 images sent by the customer, and agent model module 102-2 is trained using these 94 annotated images. Agent 200-3 annotates 115 images of the 550 images sent by the customer, and agent model module 102-3 is trained using these 115 annotated images. Agent 200-4 annotates 54 images of the 550 images sent by the customer, and agent model module 102-4 is trained using these 54 annotated images. For this example, out of the 550 images from the customer, 133 raw data images remain unannotated and are not used as training data. At the same time or soon after, the base model 216 is trained using all the annotated images from the various agents (417 images annotated by Agents 200-1 through 200-4) to result in the baseline model module 110.

### Customer Dataset Sampling:

Regarding the evaluation dataset 114, this dataset is to “grade” or evaluate the performance of the agent model module according to one or more predefined rubrics as explained above. The evaluation dataset can take different forms. In the case of a customer having a large volume of data, the evaluation dataset is sampled (process step 218) from the original dataset in repository 120. In one aspect, a conventional off-the-shelf software application may be used that compares two images and returns a value indicating how visually similar they are. The dataset is iteratively processed and a “distance” calculation is made to identify a set of images with maximum distance. Thus, the resulting set of images is selected to be as visually dissimilar to one another (i.e., the maximum contrast with one another). In one preferred embodiment, the set of images used in the evaluation dataset would have as much distance as possible with one another. It should be clear that distance may be understood to be a difference in the raw data image backgrounds or scene classification. Scene classification is an ML technique that helps identify the environment in which the raw data image was taken, such as city, country, night, day, tunnel, etc. An open source model such as EfficientNet or any other suitable image classifier can perform this function of scene classification. A maximum distance calculation is an attempt to obtain images spread across the widest number of environments. Thus, it is preferable that the evaluation dataset would have images from a large number of environments.

As an example, image 1 is taken during the day, on a highway with 10 cars. Image 2 is a picture taken on the same highway and same location, but at night, with 2 cars. Running a scene classification process, a positive score is obtained for the highway (1) as the environments are the same for the two images, and a negative for time of day (0) as the time of day is different between the two images. Image 3 is substantially the same as image 1, just taken a fraction of a second later. Scene detection scores a 1 for both images 1 and 3 then as the same environment is illustrated in the two images. An application such as OpenCV can be used to determine if the same exact image is used. OpenCV's classifier determines an image likeliness index (a number between 0 and 1), and the evaluation dataset images can be chosen with the least amount of likeliness between the images.

If the customer dataset is small, for example, less than 100 shapes annotated per shape type, the evaluation dataset may be an entirely new dataset provided by the customer. The customer dataset may also contain images that are manually inserted by the customer or by the service provider such that the inserted images are always part of the evaluation dataset. Data from a gold dataset can be added to the evaluation dataset. Because the gold dataset is ground truth, no baseline inference need be run (i.e., the baseline model module is not necessary). Instead, agent model modules are scored or assessed against the gold dataset such that the gold dataset is used as the baseline model module evaluation output against the agent model modules' evaluation outputs. Accordingly, the final evaluation dataset typically contains a set of visually diverse images (with the images being as diverse as possible). Optionally, a set of images earmarked by the customer or service provider may be included, and/or a gold dataset may be included (if one exists).

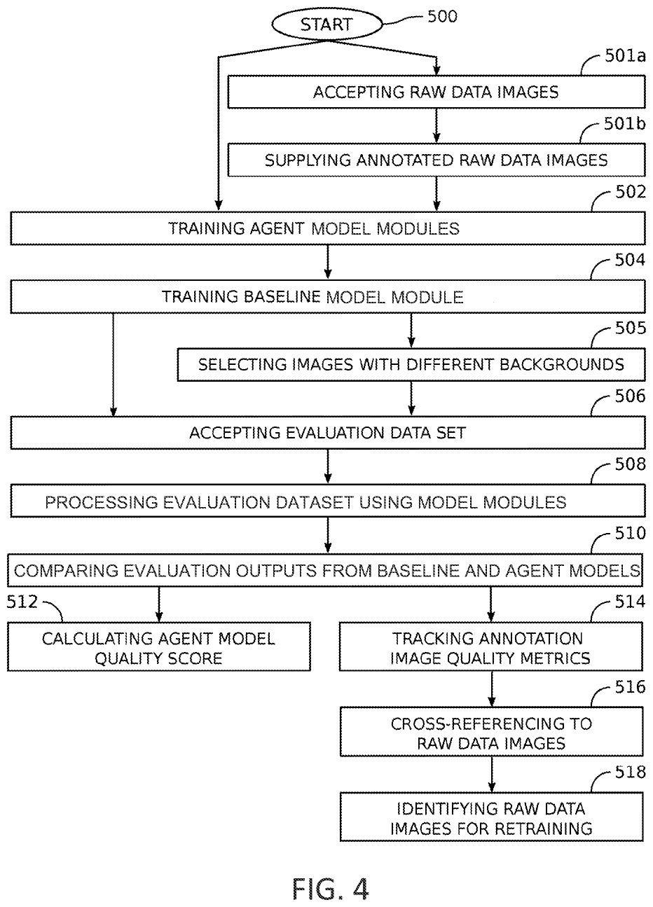

Referring to FIG. 4, FIG. 4 is a flowchart illustrating a method for ML quality assurance. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 500.

Step 502 trains a plurality of agent model modules using annotated images that have been annotated by annotator agents. Each agent model module is stored in a non-transitory memory, enabled as a sequence of processor executable steps, and trained with a corresponding subset of annotated images including annotation marks forming a boundary surrounding the first shape. As explained above, each agent model module is trained using annotated images annotated by a specific annotator. Step 504 trains a baseline model module (stored in a non-transitory memory and enabled as a sequence of processor executable steps) using all the subsets of annotated images. Step 506 accepts an evaluation dataset with unannotated images including the first shape for provision to the agent model modules and baseline model module. In one aspect, Step 506 supplies gold dataset images with accuracy verified first shape annotation marks. In another aspect, Step 505 selects evaluation dataset images to depict the first shape in a plurality of different background environments (the concept of distance, as explained above, is used).

After the evaluation dataset has been accepted in step 506, this evaluation dataset is processed using the various agent model modules and the baseline model module (Step 508) and produces evaluation outputs. The processing of the evaluation dataset produces evaluation output annotated images with annotation marks that form a boundary surrounding the first shape. Step 510 compares the evaluation output from the baseline model module against the various agent model module evaluation outputs. In one aspect, prior to training the agent model modules and the baseline model module in Steps 502 and 504, Step 501a provides a plurality of human agent UIs, with each UI accepting a corresponding subset of annotated images with the first shape. In Step 501b each UI supplies the subset of annotated images for training to a corresponding agent model. As explained above, each UI receives the annotated images from annotators and a specific UI receives annotated images from a specific annotator and these annotated images are provided to train a specific agent model module.

It should be clear that the system and method of the present invention may also be used to target bias in the annotated images. Specific annotators or groups of annotators may annotate images in a specific certain manner with a decided bias towards or away from specific objects, circumstances, or methods of annotating. By performing the method of the invention on a group of annotators and assessing the result against either another group or against a gold dataset, the bias of that group of annotators can be either detected or highlighted. For a large group of annotators, bias evens out and is less evident. However, by assessing the annotated images of a subset of that large group of annotators against the annotated images of the large group as a whole, any bias or preference shown by that subset of annotators is more readily evident. Thus, as a variant of the present invention, a baseline model module may be trained on annotated images of a large group of annotators. As above, agent model modules are each trained on annotated images annotated by specific annotators. Then, the evaluation outputs of the agent model modules are assessed against the evaluation outputs of the baseline model module. The comparison should show any biases of the annotators that correspond to the agent model modules whose evaluation outputs were assessed against the evaluation outputs of the baseline model module. In one aspect, the system and method of the present invention can be used to assess whether errors in annotation are concentrated around some object classes or whether these errors are evenly distributed.

In another aspect, the step of comparing the evaluation output of the baseline model module with the evaluation output of at least one agent model module including classification, localization, and probability. More explicitly, supplying or creating agent model module evaluation outputs includes:

making classification predictions determining a class of shapes into which falls the shape identified by the annotation marks in the baseline model module evaluation output, and in the agent model module evaluation output;

making localization predictions determining the image coordinates of the first shape identified by the annotation marks in the baseline model module evaluation output, and in the agent model module evaluation outputs; and,

making probability predictions determining the statistical probability of the localization and classification predictions being accurate.

In yet another aspect, comparing the baseline model module evaluation output to the evaluation outputs of the various agent model modules in Step 510 includes making comparisons based on agent model module output quality metrics such as activation, label accuracy, precision, tracking, and points per shape. More explicitly, comparing agent model quality metrics includes:

for each agent model module, making an activation comparison between the number of first shapes identified and the number of first shapes identified by the baseline model module in its evaluation output;

for each agent model module, making a label accuracy comparison between labels applied to identified first shapes and the labels applied to identified first shapes by the baseline model module in its evaluation output;

for each agent model module, making a precision comparison between the annotation mark outlines identifying first shapes, and in the annotation mark outlines made by the baseline model module in its evaluation output;

for each agent model module, making a tracking comparison of motion vector annotation marks for video or three-dimensional first shapes, and the motion vector annotation marks made by the baseline model module in its evaluation output; and,

for each agent model module, making a points per shape comparison between a number of points used to create polygon annotation marks and the number of points used in the polygon annotation marks made by the baseline model module in its evaluation output.

In one aspect, the method further comprises Step 512, of using the quality metrics to calculate a quality score for each agent model module. Alternatively, or in addition, Step 514 tracks the quality metrics for each agent model module produced annotated image. Step 516 cross-references minimum quality agent model module produced annotated images to corresponding unannotated data images, and Step 518 identifies the unannotated data images for use in training or retraining annotators.

### Implementation

In terms of implementation, system 100 broadly represents any type single or multi-processor computing device or system capable of executing computer-readable instructions. Examples of computing system 100 include, without limitation, workstations, laptops, client-side terminals, servers, distributed computing systems, mobile devices, network switches, network routers (e.g., backbone routers, edge routers, core routers, mobile service routers, broadband routers, etc.), network appliances (e.g., network security appliances, network control appliances, network timing appliances, SSL VPN (Secure Sockets Layer Virtual Private Network) appliances, etc.), network controllers, gateways (e.g., service gateways, mobile packet gateways, multi-access gateways, security gateways, etc.), and/or any other type or form of computing system or device.

Computing system 100 may be programmed, configured, and/or otherwise designed to comply with one or more networking protocols. According to certain embodiments, computing system 100 may be designed to work with protocols of one or more layers of the Open Systems Interconnection (OSI) reference model, such as a physical layer protocol, a link layer protocol, a network layer protocol, a transport layer protocol, a session layer protocol, a presentation layer protocol, and/or an application layer protocol. For example, computing system 100 may include a network device configured according to a Universal Serial Bus (USB) protocol, an Institute of Electrical and Electronics Engineers (IEEE) 1394 protocol, an Ethernet protocol, a T1 protocol, a Synchronous Optical Networking (SONET) protocol, a Synchronous Digital Hierarchy (SDH) protocol, an Integrated Services Digital Network (ISDN) protocol, an Asynchronous Transfer Mode (ATM) protocol, a Point-to-Point Protocol (PPP), a Point-to-Point Protocol over Ethernet (PPPoE), a Bluetooth protocol, an IEEE 802.XX protocol, a frame relay protocol, a token ring protocol, a spanning tree protocol, and/or any other suitable protocol.

Processor 106 generally represents any type or form of processing unit capable of processing data, or interpreting and executing instructions. Processor 106 may represent an application-specific integrated circuit (ASIC), a system on a chip (e.g., a network processor), a hardware accelerator, a general purpose processor, and/or any other suitable processing element. As is common with most computer system, processing is supported through the use of an operating system (OS) 136 stored in memory 104.

System memory 104 generally represents any type or form of non-volatile (non-transitory) storage device or medium capable of storing data and/or other computer-readable instructions. Examples of system memory 104 may include, without limitation, Random Access Memory (RAM), Read Only Memory (ROM), flash memory, or any other suitable memory device. Although not required, in certain embodiments computing system 104 may include both a volatile memory unit and a non-volatile storage device. System memory 104 may be implemented as shared memory and/or distributed memory in a network device. Furthermore, system memory 104 may store packets and/or other information used in networking operations.

In certain embodiments, exemplary computing system 100 may also include one or more components or elements in addition to processor 106 and system memory 104. For example, computing system 100 may include a memory controller, an Input/Output (I/O) controller, and a communication interface (not shown), as would be understood by one with ordinary skill in the art. Further, examples of communication infrastructure include, without limitation, a communication bus 138 (such as a Serial ATA (SATA), an Industry Standard Architecture (ISA), a Peripheral Component Interconnect (PCI), a PCI Express (PCIe), and/or any other suitable bus), and a network. Note that, for simplicity the communication between devices in system 100 is shown as using bus line 138, although in practice the devices may be connected on different lines using different communication protocols.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for assessing a plurality of annotators that produce annotated images, said annotated images having been annotated by said plurality of annotators, the system comprising:
a plurality of trained annotator model modules for annotating images, each of said trained annotator model modules corresponding to one of said plurality of annotators, and each of said trained annotator model modules being trained on annotated images as annotated by a specific annotator that corresponds to said trained annotator model;
a trained baseline model module for annotating images, said trained baseline model being trained on all annotated images used to train said plurality of annotator model modules;
a comparison module for comparing an evaluation output of said trained baseline model module with an evaluation output of one or more of said trained annotator model modules, said evaluation output being an output of a trained model module when an evaluation dataset is passed through said trained model module; and
a scoring module for producing scores for each of said trained annotator model modules, each score being a numerical indication of differences between said evaluation output of said trained baseline model module with said evaluation output of one of said trained annotator models, said numerical indication being based on an output of said comparison module.

2. The system according to claim 1 wherein said score is a numerical indication of differences between said evaluation output of said trained baseline model with said evaluation output of one of said trained annotator models in at least one rubric, said at least one rubric being related to at least one of: Recall, Label Accuracy, Precision/Shape Overlap, Tracking, and Points per shape.

3. The system according to claim 2 wherein said scoring module scores each of said trained annotator models separately for each of said at least one rubrics.

4. The system according to claim 1 wherein said evaluation dataset is at least one of:
a set of visually diverse images;
a set of selected images by a customer and/or an operational team; and
a gold dataset.

5. The system according to claim 1 further comprising an analysis module for analyzing scores from said scoring module.

6. The system according to claim 5 wherein said analysis module outputs a listing of said trained annotator models, said listing of trained annotator models being organized based on scores received by said trained annotator models.

7. The system according to claim 3 further comprising an analysis module for analyzing scores from said scoring module and wherein said analysis module outputs a listing of said trained annotator models, said listing of trained annotator models being organized based on scores received by said trained annotator models.

8. The system according to claim 7 wherein said listing of trained annotator models is divided into discrete groups of trained annotator models such that trained annotator models with lowest overall scores are grouped together.

9. The system according to claim 7 wherein said listing of trained annotator models is divided into discrete groups of trained annotator models such that trained annotator models with lowest scores in a given rubric are grouped together.

10. A method for assessing a plurality of annotators that produce annotated images, said annotated images being annotated by said plurality of annotators, the method comprising:
receiving a plurality of annotated images, said plurality of annotated images being annotated by said plurality of annotators;
training a plurality of annotator model modules using said plurality of annotated images such that each of said plurality of annotator model modules is trained using annotated images that have been annotated by a corresponding specific one of said plurality of annotators;
training a baseline model module using said plurality of annotated images received in step a) such that said baseline model module is trained using all of said annotated images used in training said plurality of annotator model modules;
processing an evaluation dataset using said plurality of annotator model modules to result in evaluation outputs of annotated images, each of said plurality of annotator model modules producing an evaluation output of annotated images;
processing said evaluation dataset using said baseline model module to result in a corresponding evaluation output of annotated images;
comparing evaluation outputs of each of said plurality of annotator model modules with said evaluation output of said baseline model module; and
scoring each of said plurality of annotator model modules based on results of step f) to result in at least one score for each of said plurality of annotator model modules.

11. The method according to claim 10 wherein said at least one score is a numerical indication of differences between said evaluation output of said baseline model module with said evaluation output of one of said annotator model modules in at least one rubric, said at least one rubric being related to at least one of: Recall, Label Accuracy, Precision/Shape Overlap, Tracking, and Points per shape.

12. The method according to claim 10 wherein step g) comprises scoring each of said annotator model modules separately for each of a plurality of rubrics.

13. The method according to claim 10 wherein said evaluation dataset is at least one of:
a set of visually diverse images;
a set of selected images by a customer and/or an operational team; and
a gold dataset.

14. The method according to claim 10 further comprising a step of analyzing scores resulting from step g).

15. The method according to claim 14 wherein said step of analyzing scores produces a listing of said annotator model modules, said listing of annotator model modules being organized based on scores received by said annotator model modules.

16. The method according to claim 15 wherein said listing of annotator model modules is organized based on overall scores received by said annotator model modules in a plurality of rubrics.

17. The method according to claim 15 wherein said listing of trained annotator models is divided into discrete groups of annotator model modules such that annotator model modules with lowest overall scores are grouped together.

18. The method according to claim 15 wherein said listing of trained annotator models is divided into discrete groups of annotator model modules such that annotator model modules with lowest scores in a given rubric are grouped together.

19. The method according to claim 17 wherein annotators corresponding to annotator model modules with said lowest overall scores are targeted for retraining.

20. The method according to claim 18 wherein annotators corresponding to annotator model modules with said lowest scores in a given rubric are targeted for retraining in a specific task corresponding to said rubric.
